(19) United States
(12) Patent Application Publication
(10) Pub. No.: US 2023/0422350 A1
(43) Pub. Date: Dec. 28, 2023

(54) HEATING PLATE

(71) Applicant: ShengQiang Qi, Xiangtan (CN)

(72) Inventor: ShengQiang Qi, Xiangtan (CN)

(21) Appl. No.: 17/808,108

(22) Filed: Jun. 22, 2022

(51) Int. Cl. H05B 3/06; H05B 3/56; A47K 10/06

(52) U.S. Cl. CPC H05B 3/06; H05B 3/56; A47K 10/06

(57) ABSTRACT

Provided is a heating plate, applied to a towel rack. The heating plate includes a body for hanging wet towels or cloths. The body includes a hollow metal housing, at least one receiving element fixedly received in the metal housing, and a metal heating wire. The metal heating wire is received in the receiving element and forms a heating circuit loop. The heating plate has the advantage of high heat utilization efficiency and low power consumption.

### TECHNICAL FIELD

The present disclosure relates to the technical field of bath products, in particular to a heating plate of a towel rack.

### BACKGROUND

Electric towel rack, as a bath product, is used to dry wet towels or cloths by an electric heating mode. Bacteria are prone to breed on the wet towel that hung in a closed and damp bathroom for a long time, causing that the wet towel smells bad. Therefore, regular drying and disinfecting towels hung on the towel rack are in great demand. Most of the electric towel racks on the market heat the wet towels in a drying and heating mode. In the drying and heating mode, an intermediary is adopted to transfer heat to a periphery of the electric towel rack or transfer heat into the electric towel rack, to dry the wet towels or cloths. The drying and heating mode has disadvantages such as low heat utilization efficiency and large power consumption.

### SUMMARY

In view of the above, a technical problem to be solved by the present disclosure is to provide a heating plate that improve the heat utilization efficiency and reduce the power consumption.

In one aspect, the present invention discloses a heating plate, applied to a towel rack. The heating plate includes a body for hanging wet towels or cloths. The body includes a hollow metal housing, at least one receiving element fixedly received in the metal housing, and a metal heating wire, the metal heating wire is received in the receiving element and forms a heating circuit loop.

Furthermore, the receiving element defines a through hole through which the metal heating wire passes.

Furthermore, an outer surface of the metal heating wire is sealingly connected with an inner wall of the through hole.

Furthermore, the metal heating wire is received in the through hole in a clearance fit mode.

Furthermore, the metal heating wire is received in the through hole in an interference fit mode.

Furthermore, the heating plate further includes at least one rib, configured to connect an inner wall of the metal housing with an outer wall of the receiving element.

Furthermore, the rib, the receiving element, and the metal housing are integrated formed.

Furthermore, a cross-section of the receiving element is a circle, a square, or a polygon.

Furthermore, a wall of the through hole defines at least one notch.

Furthermore, the wall of the through hole defines at least two notches spaced apart from each other.

Furthermore, the at least one receiving element includes at least two receiving elements, a gap is defined between each two adjacent receiving elements.

Furthermore, the heating plate further includes at least two ribs, configured to connect an inner wall of the metal housing with outer walls of the receiving elements.

Furthermore, two ends of the metal heating wire are exposed from the metal housing, and arranged at a same side of the hollow metal housing. Furthermore, the metal housing is made of aluminum or aluminum alloy.

Furthermore, the heating circuit loop has a reticular shape or a grid shape.

Furthermore, the metal heating wire is a carbon fiber heating wire, a resistance heating wire, or a conductive metal heating wire.

In the technical solution of the present disclosure, the heating plate includes a hollow metal housing, at least one receiving element fixedly received in the metal housing, and a metal heating wire, the metal heating wire is received in the receiving element and forms a heating circuit loop. When in use, the heating circuit loop generates a large amount of heat, and the heat is transmitted to a surface of the metal housing of the heating plate to dry the towels and cloths hung on the metal housing. As the heat generated by the heating circuit loop is transmitted to the metal housing directly, the heating plate of the present disclosure has the advantages of high heat utilization efficiency and low power consumption.

### BRIEF DESCRIPTION OF THE DRAWINGS

The technical solutions of the present disclosure are further described in detail below with reference to the accompanying drawings and embodiments.

FIG. 1 is a structure diagram of a heating plate of the present disclosure.

FIG. 2 is similar to FIG. 1, but shown from another view.

FIG. 3 is a structure diagram of a heating circuit loop of the present disclosure.

FIG. 4 is a structure diagram of a metal housing, receiving elements, and ribs of the heating plate of the present disclosure.

FIG. 5 is a cross-sectional view of the metal housing, the receiving elements, and the ribs according to a first embodiment of the present disclosure.

FIG. 6 is a cross-sectional view of the metal housing, the receiving elements, and the ribs according to a second embodiment of the present disclosure.

FIG. 7 is a cross-sectional view of the metal housing, the receiving elements, and the ribs according to a third embodiment of the present disclosure.

FIG. 8 is a cross-sectional view of the metal housing, the receiving element, and the ribs according to a fourth embodiment of the present disclosure.

FIG. 9 is a cross-sectional view of the metal housing, the receiving elements, and the ribs according to a fifth embodiment of the present disclosure.

FIG. 10 is a cross-sectional view of the metal housing, the receiving elements, and the ribs according to a sixth embodiment of the present disclosure.

### DETAILED DESCRIPTION OF THE EMBODIMENTS

In the following, the technical schemes in the embodiments of the present application will be described clearly and completely with reference to the drawings of the embodiments of the present application. Obviously, the described embodiments are only a part of embodiments of the present application, not all of the embodiments. Based on the embodiments in the present application, all other embodiments obtained by ordinary technicians in the field without creative labor are within the scope of protection in the present application.

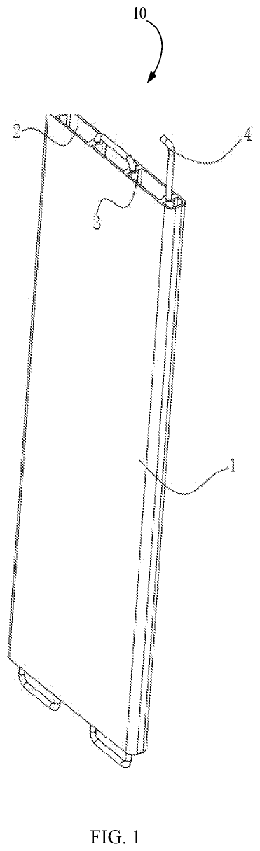

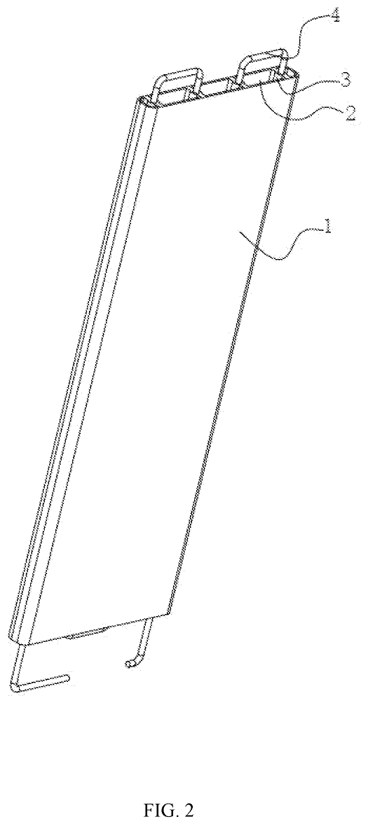

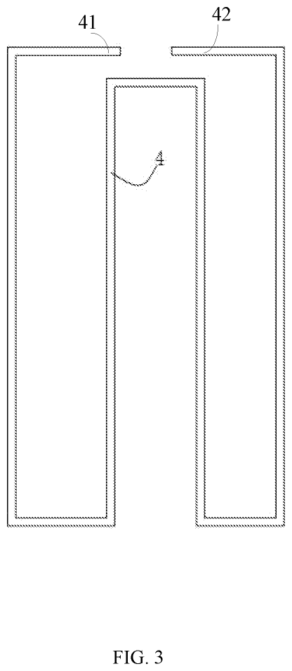

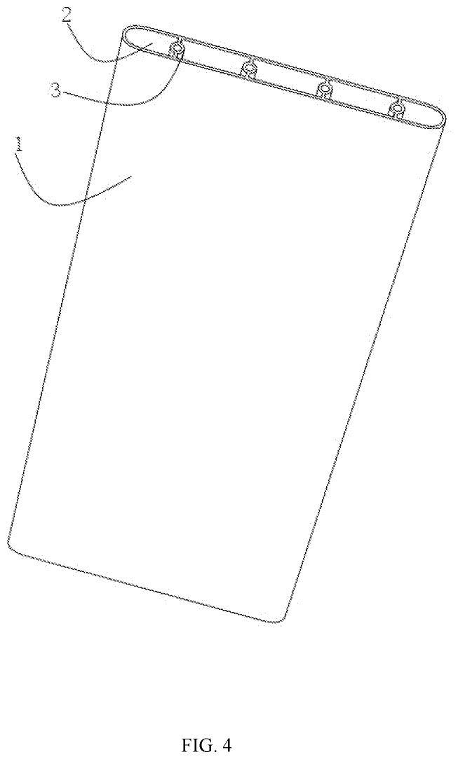

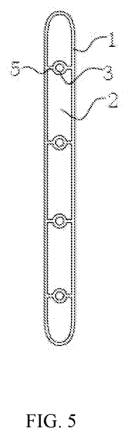

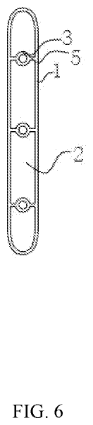

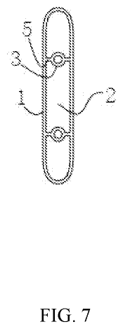

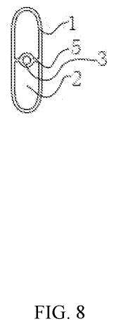

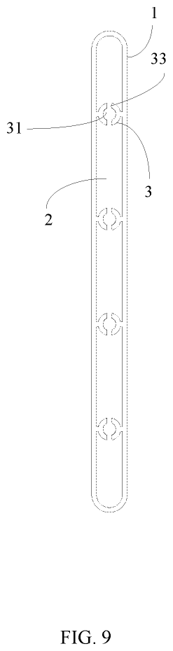

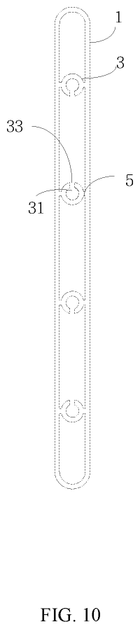

Referring to FIGS. 1 to 10, the present disclosure provides a heating plate according to a first embodiment. The heating plate is an important part of a towel rack or an electric towel rack, and the heating plate includes a body for hanging wet towels or cloths.

The body includes a hollow metal housing 1, at least one receiving element 3 fixedly received in the metal housing 1, and a metal heating wire 4. The receiving element 3 defines a through hole 31 through which the metal heating wire 4 passes. The metal heating wire 4 is received in the receiving element 3 and forms a heating circuit loop.

In an embodiment, the metal housing 1 is made of a metal conductive material, such as, aluminum, aluminum alloy, or the like.

In an embodiment, an outer wall of the through hole 31 is separated from an inner surface of the metal housing 1.

In an embodiment, there are a plurality of receiving elements 3, each receiving element 3 has one through hole 31.

In an embodiment, a gap 2 is arranged between each two adjacent receiving elements 3.

In an embodiment, the receiving element 3 is weld to the metal housing 1.

In an embodiment, the receiving element 3 is a hollow cylinder, a cross-section of the receiving element 3 is a circle, a square, or a polygon.

In an embodiment, a wall of the through hole 31 defines at least one notch 33.

In an embodiment, the wall of the through hole 31 defines at least two notches 33 spaced apart from each other.

In an embodiment, the wall of the through hole 31 defines two notches 33 facing toward each other.

In an embodiment, the metal heating wire 4 is received in the through hole 31 of the receiving element 3.

In an embodiment, the metal heating wire 4 is received in the through holes 31 of the receiving elements 3.

In an embodiment, an outer surface of the metal heating wire 4 is sealingly connected with the inner wall of the through hole 31; or the metal heating wire 4 is received in the through hole 31 in a clearance fit mode; or the metal heating wire 4 is received in the through hole 31 in an interference fit mode.

In an embodiment, an outer surface of the metal heating wire 4 is sealingly connected with inner walls of the through holes 31; or the metal heating wire 4 is received in the through holes 31 in a clearance fit mode; or the metal heating wire 4 is received in the through holes 31 in an interference fit mode.

In an embodiment, the metal heating wire 4 is a carbon fiber heating wire, a resistance heating wire, or a conductive metal heating wire.

The heating plate further include at least one rib 5 for connected the inner surface of the metal housing 1 with the outer wall of the receiving element 3.

In an embodiment, there are a plurality of ribs 5.

In an embodiment, the rib 5, the receiving element 3, and the metal housing 1 are integrated formed.

In an embodiment, a first end 41 of the metal heating wire 4 passes through the through hole 31 of the receiving element 3, and exposes from the metal housing 1, a second end 42 of the metal heating wire 4 also exposes from the metal housing 1, the first end 41 and the second end 42 of the metal heating wire 4 are arranged at two opposite sides of the metal housing 1.

In an embodiment, a first end 41 of the metal heating wire 4 passes through the through holes 31 of the receiving elements 3 in sequence, and exposes from the metal housing 1, a second end 42 of the metal heating wire 4 also exposes from the metal housing 1. After passing through the through holes 31 of the receiving elements 3, the metal heating wire 4 forms the heating circuit loop with a reticular shape or a grid shape, the first end 41 and the second end 42 of the metal heating wire 4 are arranged at the same side of the metal housing 1.

In an embodiment, a first end 41 of the metal heating wire 4 passes through the through holes 31 of the receiving elements 3 in sequence, and exposes from the metal housing 1, a second end 42 of the metal heating wire 4 also exposes from the metal housing 1. After passing through the through holes 31 of the receiving elements 3, the metal heating wire 4 forms the heating circuit loop with a reticular shape or a grid shape, the first end 41 and the second end 42 of the metal heating wire 4 are arranged at two opposite sides of the metal housing 1.

When in use, the heating circuit loop of the metal heating wire 4 generates a large amount of heat, and the heat is directly transmitted to a surface of the metal housing 1 of the heating plate to dry the towels and cloths hung on the metal housing 1. In the existing art, a large amount of heat is wasted in the process of transferring heat to the towel rack through an intermediate medium. Therefore, the present disclosure has a high heat utilization efficiency and a lower power consumption.

The above description is only about some embodiments of the present application, and is not intended to limit the patent scope of the present application. Any equivalent structure or equivalent principle transformation made by using the description and drawings of the present application, or directly or indirectly applied in other related technical fields, are similarly included in the patent protection scope of the present application.

What is claimed is:

1. A heating plate, applied to a towel rack, comprising:
a body, for hanging wet towels or cloths, the body comprises:
a hollow metal housing;
at least one receiving element, fixedly received in the metal housing; and
a metal heating wire, the metal heating wire is received in the receiving element and forms a heating circuit loop.

2. The heating plate of claim 1, wherein the receiving element defines a through hole through which the metal heating wire passes.

3. The heating plate of claim 2, wherein an outer surface of the metal heating wire is sealingly connected with an inner wall of the through hole.

4. The heating plate of claim 2, wherein the metal heating wire is received in the through hole in a clearance fit mode.

5. The heating plate of claim 2, wherein the metal heating wire is received in the through hole in an interference fit mode.

6. The heating plate according to claim 1, wherein further comprising at least one rib, configured to connect an inner wall of the metal housing with an outer wall of the receiving element.

7. The heating plate according to claim 6, wherein the rib, the receiving element, and the metal housing are integrated formed.

8. The heating plate according to claim 1, wherein a cross-section of the receiving element is a circle, a square, or a polygon.

9. The heating plate according to claim 1, wherein a wall of the through hole defines at least one notch.

10. The heating plate according to claim 9, wherein the wall of the through hole defines at least two notches spaced apart from each other.

11. The heating plate according to claim 1, wherein the at least one receiving element comprises at least two receiving elements, a gap is defined between each two adjacent receiving elements.

12. The heating plate according to claim 11, wherein further comprising at least two ribs, configured to connect an inner wall of the metal housing with outer walls of the receiving elements.

13. The heating plate according to claim 1, wherein two ends of the metal heating wire are exposed from the metal housing, and arranged at a same side of the hollow metal housing.

14. The heating plate according to claim 1, wherein the metal housing is made of aluminum or aluminum alloy.

15. The heating plate according to claim 1, wherein the heating circuit loop has a reticular shape or a grid shape.

16. The heating plate according to claim 1, wherein the metal heating wire is a carbon fiber heating wire, a resistance heating wire, or a conductive metal heating wire.
